(19) United States
(12) Patent Application Publication
(10) Pub. No.: US 2005/0120528 A1
(43) Pub. Date: Jun. 9, 2005

(54) Method of manufacturing piezoelectric ceramic device

(76) Inventors: Kazuhiro Okuda, Katano-shi (JP); Yasushi Goto, Ikeda-shi (JP); Seiichi Minami, Sapporo-shi (JP); Hiroki Moriwake, Sanda-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/998,034

(22) Filed: Nov. 29, 2004

(30) Foreign Application Priority Data
Dec. 8, 2003 (JP) 2003-408610

(51) Int. Cl. H04R 17/00

(52) U.S. Cl. 29/25.35; 310/313 R; 29/25.42

(57) ABSTRACT

An un-sintered green sheet made of first piezoelectric ceramic composite essentially including lead oxide is provided. Conductive paste made of metal essentially including Ag, second piezoelectric ceramic composite, and oxide is provided. The conductive paste partly is applied onto the green sheet. The green sheet having the conductive paste thereon is fired at a temperature lower than a melting temperature of the oxide in the conductive paste so as to sinter the green sheet, thus providing a piezoelectric ceramic device. The piezoelectric ceramic device manufactured by the method does not cause deformation or crack when the green sheet is sintered.

### FIELD OF THE INVENTION

The invention relates to a method of manufacturing a multilayer piezoelectric ceramic device, such as a multilayer piezoelectric actuator and a multilayer piezoelectric transformer, which have a multilayer construction including an internal electrode essentially containing Ag and a ceramic layer of piezoelectric ceramic composite.

### BACKGROUND OF THE INVENTION

In accordance with a recent demand of small, thin, and high performance products, a multilayer piezoelectric ceramic device, such as a piezoelectric oscillator, a piezoelectric filter, a piezoelectric actuator, a piezoelectric transformer, and a piezoelectric buzzer, have been developed.

The piezoelectric ceramic device has a multilayer construction including an internal electrode and a ceramic layer of piezoelectric ceramic composite. For cost reduction, the internal electrode is made essentially of Ag. The piezoelectric ceramic composite is made essentially of lead oxide. Green sheets made of the piezoelectric ceramic composite which are not sintered and internal electrodes made essentially of Ag are alternately stacked, and are fired simultaneously. When fired, Ag, essential material of the internal electrodes facilitates sintering of the piezoelectric ceramic composite. At this moment, a portion of the green sheet contacting the internal electrode, i.e. a laminated construction portion and a portion of the green sheet not contacting the internal electrode, i.e. a non-laminated portion has thermal contraction rates different from each other. The difference causes deformation and crack at a boundary between the laminated construction portion and the non-laminated construction portion, thus reducing reliability of the piezoelectric ceramic device.

Japanese Patent No.2883896 discloses a conventional method for solving the problem. In the method, a non-laminated construction portion of a green sheet is manufactured by press-molding powder provided at a temperature lower than a temperature for providing piezoelectric ceramic powder for forming a laminated construction portion. This arrangement increases a thermal contraction rate of the non-laminated construction portion, thereby matching thermal contraction rate of the non-laminated construction portion with the laminated construction portion having a thermal contraction rate increasing due to influence of the internal electrode.

Japanese Patent Laid-Open Publication No.9-270540 discloses another conventional method for solving the above problem. In to the method, a laminated construction of an internal electrode and a green sheet is formed at a portion where the laminated construction of the green sheet is not required. This structure increases contraction of the portion where the laminated construction is formed and the portion where the laminated construction is not formed due to influence of Ag, hence matching a thermal contraction rate of the portion where the laminated construction is formed with a thermal contraction rate of the portion where it is not formed.

Japanese Patent No.2666758 discloses a further conventional method for solving the problem. In the method, amount of lead included in a portion where the laminated construction is not formed is larger than that of a portion where the laminated construction is formed. The excessively added lead facilitates thermal contraction of the portion where the laminated portion is not formed. This arrangement allows the contraction rate of the portion not having the laminated portion to match with the contraction rate of the portion having the laminated construction which increases due to influence of the internal electrode.

Each of the three documents describes that, when manufacturing a multilayer piezoelectric ceramic device using piezoelectric ceramic composite made essentially of lead oxide, a contraction rate of a laminated construction portion contacting the internal electrodes becomes larger than a contraction rate of a non-laminated construction portion since conductive metal contained in the internal electrode diffuses into the green sheet (ceramic layer) facilitates the sintering.

Moreover, a multilayer piezoelectric ceramic device having the laminated construction portion of the internal electrode and the green sheet and the non-laminated construction portion on one green sheet, such as a multilayer piezoelectric transformer, can not be manufactured easily by the conventional methods disclosed in the three documents. It is because metal contained in the internal electrode facilitates the sintering of the green sheet, hence making the thermal contraction rate of the laminated construction portion larger than the non-laminated construction portion. This causes deformation and crack around the boundary between the laminated construction portion and the non-laminated construction portion.

### SUMMARY OF THE INVENTION

An un-sintered green sheet made of first piezoelectric ceramic composite essentially including lead oxide is provided. Conductive paste made of metal essentially including Ag, second piezoelectric ceramic composite, and oxide is provided. The conductive paste partly is applied onto the green sheet. The green sheet having the conductive paste thereon is fired at a temperature lower than a melting temperature of the oxide in the conductive paste so as to sinter the green sheet, thus providing a piezoelectric ceramic device.

The piezoelectric ceramic device manufactured by the method does not cause deformation or crack when the green sheet is sintered.

### BRIEF DESCRIPTION OF THE DRAWINGS

FIG. 1 is an exploded perspective view of a multilayer piezoelectric ceramic device in accordance with an exemplary embodiment of the present invention.

FIG. 2 is a perspective view of a multilayer piezoelectric transformer in accordance with the embodiment.

FIG. 3 shows processes for manufacturing the multilayer piezoelectric transformer in accordance with the embodiment.

FIG. 4 shows a difference of thermal contraction of a green sheet of the multilayer piezoelectric transformer in accordance with the embodiment.

FIG. 5 is a cross-sectional view of the multilayer piezoelectric transformer in accordance with the exemplary embodiment for showing a method of measuring a deforming amount of a green sheet of the transformer.

FIGS. 6A and 6B show evaluation results of the multilayer piezoelectric transformer in accordance with the embodiment.

### DESCRIPTION OF THE PREFERRED EMBODIMENT

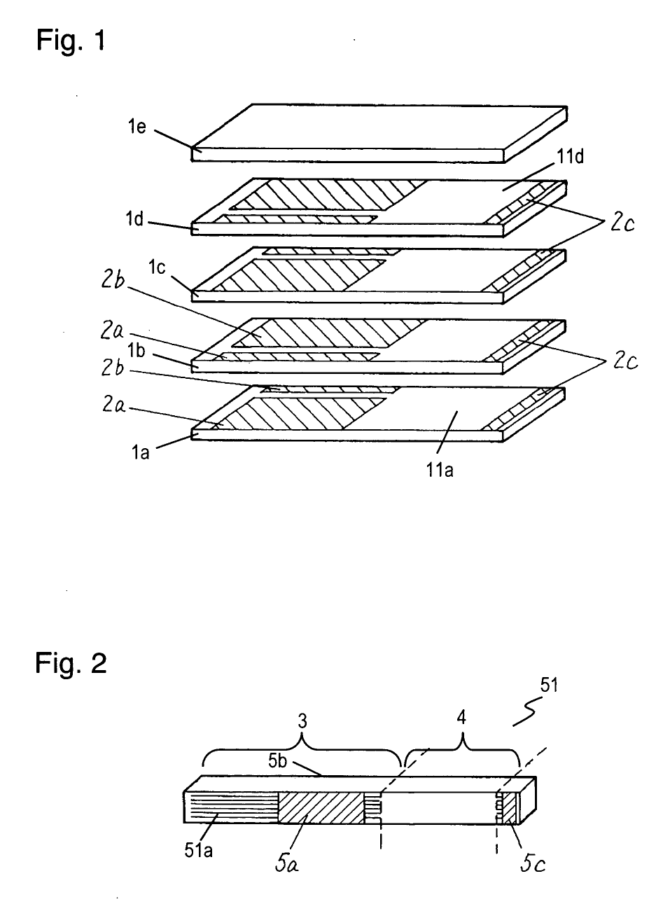

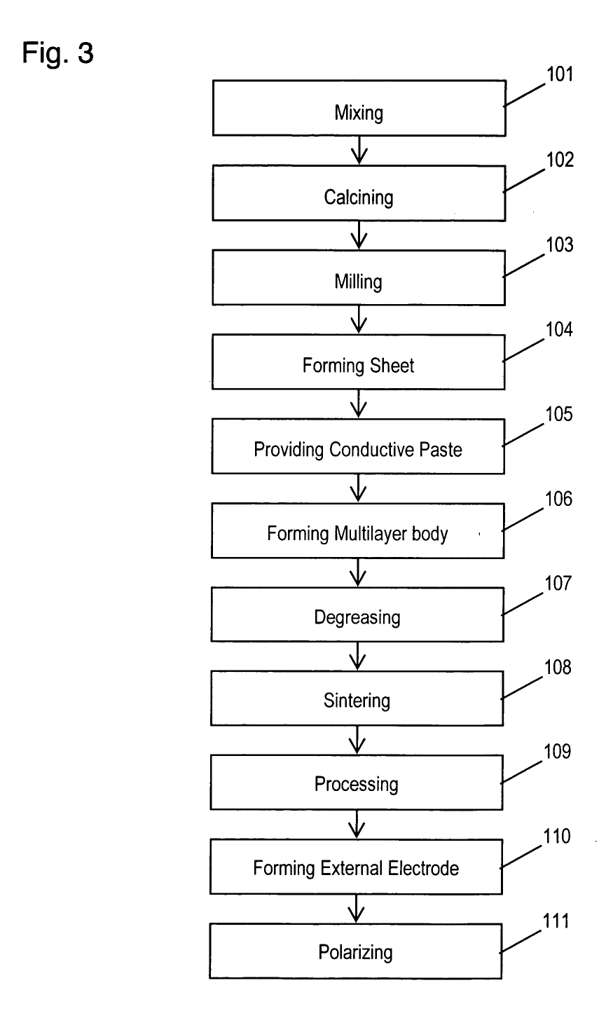

FIG. 1 is an exploded perspective view of a multilayer piezoelectric transformer, a multilayer piezoelectric ceramic device, according to an exemplary embodiment of the present invention. FIG. 2 is a perspective view of the multilayer piezoelectric transformer. FIG. 3 shows processes for manufacturing the multilayer piezoelectric transformer.

First, material, powder of lead oxide (PbO), titanium oxide(TiO), and zirconium oxide (ZrO₂), is weighed and mixed. Then, the material is put in a pot mill with water and partially-stabilized zirconia balls as medium, and the pot mill is rotated for 20 hours for mixing the material, thus providing slurry (Step 101). The weight of the material is equal to the weight of the water. The zirconia ball has a diameter not larger than 5 mm.

Then, the slurry provided is moved onto a wide flat surface, such as a stainless tray, and dried in a drier at 200° C. for a whole day and night. Then, the dried slurry is roughly ground in a mortar. The material ground is then put into a sagger of alumina, and is calcined for two hours at a temperature-rising speed of 200° C./hour and at a maximum temperature of 800° C., thus providing calcined powder (step 102).

Next, the calcined powder is ground with a rotor mill, a disk mill, or other grinder, to obtain ground powder, and then, the ground powder is put into a pot mill with water and partially-stabilized zirconia balls as medium. The pot mill is rotated for 10 hours to obtain slurry. The slurry is moved onto a wide flat surface, such as stainless tray, and dried in a dryer at 200° C. for a whole day and night. The dried slurry is ground, thus providing piezoelectric ceramic powder made essentially of lead oxide (Step 103).

The piezoelectric ceramic powder is mixed with organic binder, a plastic solvent, and organic solvent to provide piezoelectric ceramic slurry. The piezoelectric slurry is shaped by a doctor blade method in a sheet having a predetermined thickness, thus providing green sheets 1a-1e of piezoelectric ceramic composite (Step 104).

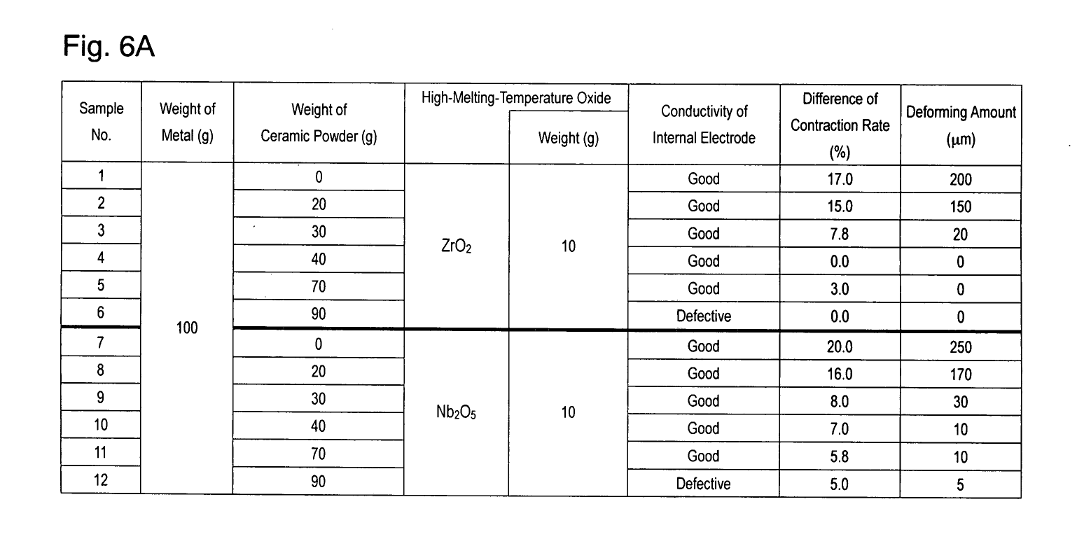

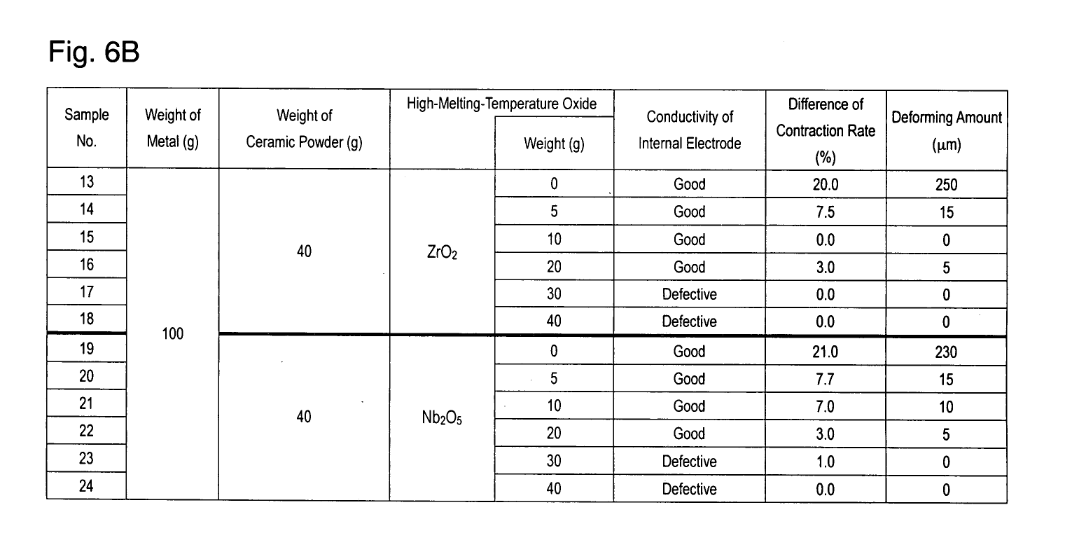

Next, the piezoelectric ceramic powder made essentially of lead oxide which has been provided at Step 103, and powder of high-melting-temperature oxide having a melting temperature higher than a temperature for sintering the green sheet are added to conductive paste made essentially of Ag, as shown in FIGS. 6A and 6B. The conductive paste including the piezoelectric ceramic powder and the high-melting-temperature oxide powder is mixed and kneaded with a triple-roller mill to disperse the powders uniformly in the paste. Then, the conductive paste is diluted in organic solvent, such as butyl carbitol or terpinenol, to adjust the viscosity of the paste at 10,000 to 25,000 mPa.sec, thus providing electrode paste (Step 105).

Then, the electrode paste is applied partly onto plane 11a of green sheet 1a of piezoelectric ceramic composite so as to print internal electrodes 2a, 2b, and 2c having thicknesses of approximately 10 μm after dried, as shown in FIG. 1. Then, green sheet 1b which is not have an internal electrode printed thereon is stacked on plane 11a of green sheet 1a. A pressure is then applied to green sheets 1a and 1b, and again, internal electrodes 2a, 2b, and 2c are printed. The stacking of green sheets 1a-1d, the pressing, and the printing of internal electrodes are repetitively executed similarly, as shown in FIG. 1 to obtain predetermined characteristics. Then, green sheet 1e is stacked on green sheet lid, and a pressure of 18 MPa is applied to the stacked green sheets 1a-1e. Then the pressed sheets are divided with a cutting machine into pieces having predetermined dimensions, thus providing a multilayer body having a substantial rectangular shape (Step 106).

Next, the multilayer body is degreased at a temperature lower than a temperature for sintering the green sheets and the internal electrodes for removing organic compounds from the multilayer body (Step 107).

Next, the multilayer body obtained at Step 107 is fired at a temperature (e.g. 1200° C.) lower than the melting temperature of the oxide added into the electrode paste so as to sinter the green sheets and the internal electrodes together, thus providing a multilayer piezoelectric element having the piezoelectric ceramic layers (Step 108).

Then, the obtained multilayer piezoelectric element is processed to have the multilayer body polished to allow internal electrodes 2a, 2b and 2c on side 51a of the multilayer piezoelectric element (Step 109).

Then, Ag paste containing glass frit is applied on a predetermined position of side 51a and is dried. The multilayer piezoelectric element is heated at about 700° C. for 10 minutes to glaze the Ag paste, thus providing external electrodes 5a, 5b, and 5c on the multilayer piezoelectric element, as shown in FIG. 2 (Step 110).

Then, finally the multilayer piezoelectric element obtained in step 110 is immersed in silicon oil at a temperature of 100° C. An electric field of 3 kV/mm is applied between internal electrodes 2a and 2b for 30 minutes, and then, an electric field of 2 kV/mm is applied between a coupling of internal electrodes 2a and 2b and internal electrode 2c for 30 minutes to polarize the ceramic layers, thus providing multilayer piezoelectric transformer 51 shown in FIG. 2 (Step 111).

Multilayer piezoelectric transformer 51 according to the embodiment has a length of 30 mm, a thickness of 2.4 mm, and a width of 5.8 mm. The internal electrode has a length of 18 mm. The piezoelectric ceramic layer has a thickness of about 0.15 mm. Multilayer piezoelectric transformer 51 has seventeen piezoelectric ceramic layers and sixteen layers of the internal electrode.

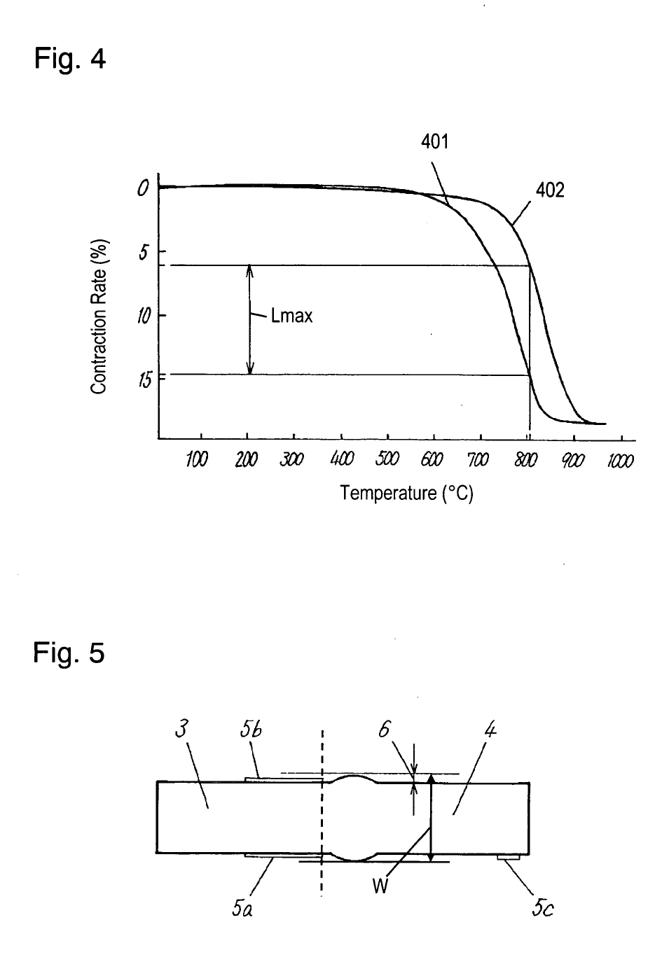

Green sheets 1a-1e of the multilayer body provided at Step 107 has portion 3 and portion 4. Portion 3 has internal electrodes 2a, 2b, and 2c therein and contact internal electrodes. In portion 4, two green sheets of green sheets 1a-1e adjacent to each other contact each other. The multilayer body is divided into portion 3 and portion 4. Portions 3 and 4 are put in a thermal mechanical analyzer (TMA). A temperature of portion 3 and 4 is raised at a rate of 200° C./hour and held for 2 hours at a temperature for sintering the green sheets. While fired, thermal contraction rates of portions 3 and 4 are measured. According to thermal mechanical analysis, a maximum difference Lmax between the contraction rates of portions 3 and 4 was obtained. FIG. 4 shows thermal contraction rate 401 of portion 3, thermal contraction rate 402 of portion 4, and maximum difference Lmax between the thermal contraction rates.

FIG. 5 shows a method of measuring deforming amounts of portions 3 and 4 in this process. Deforming amount 6 is obtained by measuring width W around a boundary between portions 3 and 4 which expands most. It was confirmed that deforming amount 6 not larger than 30 μm does not cause an inside crack and does not affect or an outside appearance.

FIGS. 6A and 6B show a weight of the metal essentially including silver (Ag) in the conductive paste forming internal electrodes 2a, 2b and 2c of samples manufactured by the processes shown in FIG. 3, a weight of the piezoelectric ceramic powder added to the conductive paste, and a kind and a weight of the high-melting oxide added to the conductive paste. FIGS. 6A and 6B also show maximum contraction difference Lmax(%) and deforming amount 6 of the samples.

Sample Nos. 3-5 and 9-11 include of conductive paste composed of 100 g (100 parts by weight) of metal including essentially of Ag, 30-70 g (30-70 parts by weight) of the piezoelectric ceramic powder obtained at Step 103, and 10 g (10 parts by weight) of the high-melting oxide (ZrO₂, Nb₂O₅) and exhibit maximum contraction difference Lmax not larger than 8% between portion 3 where the internal electrodes contact each other and portion 4 which does not contact internal electrodes. Accordingly, deforming amount 6 near the boundary between portions 3 and 4 was not larger than 30 cm, thus ranging within a target range. Thus, sample Nos. 3-5 and 9-11 did not deform or have crack therein. The high-melting-temperature metal may be MoO₃, oxide of 4 d transition element

Sample Nos. 14-16 and 20-22 include conductive paste composed of 100 g (100 parts by weight) of the metal, 40 g (40 parts by weight) of the piezoelectric ceramic powder, and 5-20 g (5-20 parts by weight) of the high-melting oxide (ZrO₂, Nb₂O₅), and exhibit the maximum thermal contraction difference were all less than 8%. Accordingly, deforming amounts 6 near the boundary between portion 3 and portion 4 were all less than 30 μm within the target range. Thus, the samples did not deform and did not have internal crack therein.

Sample Nos. 1 and 7 include conductive paste composed of the metal essentially including Ag and the high-melting-temperature oxide, but do not include the piezoelectric ceramic powder. In the samples, contraction of portion 3 by sintering is facilitated, so that the maximum contraction difference Lmax between portions 3 and 4 exceeds 8%. The samples accordingly deformed at deforming amounts 6 not less than 30 μm, thus not having target characteristics.

Sample Nos. 13 and 19 include conductive paste composed of the piezoelectric ceramic powder and the metal essentially including Ag but do not include the high-melting-temperature oxide. In these samples, contraction by sintering at portion 3 is facilitated, maximum contraction difference Lmax exceeds 8%, and the deforming amount was not less than 30 μm, thus not having the target characteristics.

Sample Nos. 2 and 8 include conductive ceramic powder composed of 100 g (100 parts by weight) of the metal essentially made of Ag, 10 g (10 parts by weight) of the high-melting-temperature oxide, and 20 g (20 parts by weight) of the piezoelectric ceramic powder. In there samples, the amount of the piezoelectric ceramic powder is not enough, and the contraction at portion 3 of the multilayer body was facilitated, so that maximum contraction difference Lmax between portion 3 and portion 4 was larger than 8%, and the deforming amount exceeded 30 μm, thus not having the target characteristics.

Sample Nos. 6, 12, 17, 18, 23 and 24 contain excessively large amounts of the piezoelectric ceramic powder and the high-melting-temperature oxide with reference to the amount of the metal essentially including Ag. In these samples, the metal included in the conductive paste was isolated, and the internal electrode was not electrically conducted, thus disabling the internal electrode to function as an electrode.

As described, in the multilayer piezoelectric ceramic device including conductive paste composed of metal essentially including Ag but without the piezoelectric ceramic powder or the high-melting-temperature oxide, Ag in internal electrode 2a and 2b diffuses into green sheets 1a-1e along grain boundaries of green sheets 1a-1e and are sintered in liquid-phase during the sintering process at Step 108, so that the portion 3 contacting the internal electrodes is sintered more than portion 4 not contacting the internal electrodes. In the conductive paste composed of the metal essentially including Ag including the high-melting-temperature oxide and the piezoelectric ceramic powder of material of green sheets 1a-1e, Ag is consumed when the high-melting-temperature oxide and the piezoelectric ceramic powder are sintered. Therefore, Ag in the conductive paste is prevented from diffusing into green sheets 1a-1e, and the sintering of the internal electrodes and portion 3 of green sheets 1a-1e contacting the conductive paste is not facilitated. This reduces the difference in thermal contraction between portion 3 contacting the internal electrodes and portion 4 not contacting the conductive paste.

According to the embodiment, lead zirconate titanate is employed as the piezoelectric ceramic composite essentially made including lead oxide. However, piezoelectric ceramic composite made of composite oxide, such as three- and four-components-composite oxide, including lead zirconate titanate including niobium oxide, zinc oxide, manganese oxide, tin oxide, antimony oxide, nickel oxide, or magnesium oxide added thereto may be employed with similar effects.

According to the embodiment, ceramic powder identical to the ceramic powder of the green sheets is added to the conductive paste forming the internal electrodes, however, ceramic powder, such as Pb(Zr,Ti)O₃, Pb(Zn,Nb)O₃, Pb(Sb,Nb)O₃, different from that in the green sheets may be added.

The multilayer piezoelectric ceramic device according to the embodiment, such as the multilayer piezoelectric transformer including portion 3 contacting the internal electrodes of the conductive paste and portion 4 not contacting the conductive paste formed on the same plane, is explained. However, multilayer piezoelectric ceramic devices having a similar construction, such as a multilayer piezoelectric actuator, a multilayer piezoelectric motor, and a multilayer piezoelectric oscillator, have the same effects. Multilayer piezoelectric ceramic devices, such as a multilayer piezoelectric actuator, in which portion 3 contacting internal electrodes and portion 4 not contacting internal electrodes are located in a direction for stacking the green sheets, have the same effects.

1. A method of manufacturing a piezoelectric ceramic device, comprising:
providing an un-sintered green sheet made of first piezoelectric ceramic composite essentially including lead oxide;
providing conductive paste made of metal essentially including Ag, second piezoelectric ceramic composite, and oxide;
applying the conductive paste partly onto the green sheet; and
firing the green sheet having the conductive paste thereon at a temperature lower than a melting temperature of the oxide in the conductive paste so as to sinter the green sheet.

2. The method of claim 1,
wherein said applying the conductive paste partly onto the green sheet comprises providing a first portion of the green sheet which contacts the conductive paste and a second portion of the green sheet which does not contact the conductive paste, and
wherein a difference between thermal contraction rates of the first portion and the second portion is not larger than 8%.

3. The method of claim 1, wherein the oxide comprises at least one of ZrO₂, Nb₂O₅, and MoO₃.

4. The method of claim 1, wherein the conductive paste includes 100 parts by weight of the metal and 30-70 parts by weight of the second piezoelectric ceramic composite.

5. The method of claim 4, wherein the conductive paste includes 5-20 parts by weight of the oxide.

6. The method of claim 1, wherein the second piezoelectric ceramic composite is identical to the first piezoelectric ceramic composite.
